(19) United States
(12) Patent Application Publication
(10) Pub. No.: US 2016/0005415 A1
(43) Pub. Date: Jan. 7, 2016

(54) AUDIO SIGNAL PROCESSING APPARATUS AND AUDIO SIGNAL PROCESSING METHOD THEREOF

(71) Applicant: ARC CO., LTD., Kaohsiung City (TW)

(72) Inventors: Ping Kai HUANG, Kaohsiung City (TW); Jian Zhang CHEN, Kaohsiung City (TW); Che Yi LIN, Kaohsiung City (TW); Bo Yu CHU, Kaohsiung City (TW)

(21) Appl. No.: 14/599,876

(22) Filed: Jan. 19, 2015

(30) Foreign Application Priority Data
Jul. 4, 2014 (TW) 103123132

(51) Int. Cl. G10L 19/03; G10L 19/02

(52) U.S. Cl. CPC G10L 19/03; G10L 19/0204

(57) ABSTRACT

An audio signal processing apparatus and an audio signal processing method thereof are provided. The audio signal processing apparatus is configured to receive an audio signal and divide the audio signal into a plurality of frames. The audio signal processing apparatus is also configured to apply Fourier Transform on each of the frames to obtain a plurality of acoustic spectra. The audio signal processing apparatus is also configured to apply Fourier Transform again on each of component combinations corresponding to respective acoustic frequencies in these acoustic spectra to obtain a two-dimensional joint frequency spectrum. The two-dimensional joint frequency spectrum has an acoustic frequency dimension and a modulation frequency dimension. The audio signal processing apparatus is also configured to calculate at least one feature of the audio signal according to the two-dimensional joint frequency spectrum.

This application claims priority to Taiwan Patent Application No. 103123132 filed on Jul. 4, 2014, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a processing apparatus and a processing method thereof. More particularly, the present invention relates to an audio signal processing apparatus and an audio signal processing method thereof.

2. Descriptions of the Related Art

With rapid development of the digital music in networks and personal devices, it is important to manage the large amount of music pieces collected. In order to manage the large amount of music pieces collected, it is often necessary to append various pieces of information to the music pieces. The information that can be appended includes, for example, the artist, the album, the music name and so on. However, these conventional appended information cannot satisfy the need of some special applications, e.g., the music therapy. Instead, the appended information shall further comprise the music genre capable of describing the music content and/or the music mood capable of describing the essential emotions in the music pieces.

To satisfy the need of various special applications, the music pieces must necessarily be classified, identified and tuned in a systematic way. For this reason, many audio signal processing technologies have been developed. The more accurate the features retrieved from an audio signal is, the more appropriate the subsequent processing performed on the audio signal such as classifying, identifying and tuning will be. Therefore, effectively retrieving the features of an audio signal becomes the primary concern for various audio signal processing technologies.

In view of this, an urgent need exists in the art to provide a technology capable of effectively retrieving features of an audio signal.

### SUMMARY OF THE INVENTION

The primary objective of the present invention is to provide a technology capable of effectively retrieving features of an audio signal.

To achieve the aforesaid objective, the present invention provides an audio signal processing apparatus, which comprises a receiver and a processor electrically connected to the receiver. The receiver is configured to receive an audio signal. The processor is configured to divide the audio signal into a plurality of frames, apply Fourier Transform on each of the frames to obtain a plurality of acoustic spectra, apply Fourier Transform again on each of component combinations corresponding to respective acoustic frequencies in the acoustic spectra to obtain a two-dimensional joint frequency spectrum, wherein the two-dimensional joint frequency spectrum comprises an acoustic frequency dimension and a modulation frequency dimension, and calculate at least one feature of the audio signal according to the two-dimensional joint frequency spectrum.

To achieve the aforesaid objective, the present invention provides an audio signal processing method for use in an audio signal processing apparatus, the audio signal processing apparatus comprises a receiver and a processor, and the audio signal processing method comprises the following steps of:

receiving an audio signal by the receiver;

dividing the audio signal into a plurality of frames by the processor;

applying Fourier Transform on each of the frames by the processor to obtain a plurality of acoustic spectra;

applying Fourier Transform again on each of component combinations corresponding to respective acoustic frequencies in these acoustic spectra by the processor to obtain a two-dimensional joint frequency spectrum, wherein the two-dimensional joint frequency spectrum has an acoustic frequency dimension and a modulation frequency dimension; and calculating at least one feature of the audio signal according to the two-dimensional joint frequency spectrum by the processor.

According to the above descriptions, the present invention provides an audio signal processing apparatus and an audio signal processing method thereof. The audio signal processing apparatus and the audio signal processing method thereof can calculate a two-dimensional joint frequency spectrum for an audio signal, and then calculate features of the audio signal according to the two-dimensional joint frequency spectrum. Because the two-dimensional joint frequency spectrum is obtained by applying Fourier Transform on each of component combinations corresponding to respective acoustic frequencies in a plurality of acoustic spectra, the features that are obtained through calculation according to the two-dimensional joint frequency spectrum not only comprise frequency combinations within short-terms, but also take interactions between individual frames of the audio signal into account. Therefore, as compared to the features of the audio signal that are obtained through calculation according to the conventional audio signal processing technologies, the features that are obtained through calculation according to the two-dimensional joint frequency spectrum are more representative of the audio signal.

The detailed technology and preferred embodiments implemented for the subject invention are described in the following paragraphs accompanying the appended drawings for persons skilled in this field to well appreciate the features of the claimed invention.

### BRIEF DESCRIPTION OF THE DRAWINGS

A brief description of drawings of this application is made as the following, but this is not intended to limit the present invention.

FIG. 1 is a schematic structural view of an audio signal processing apparatus according to an embodiment of the present invention;

FIGS. 2A-2C are schematic views illustrating operations of a processor of an audio signal processing apparatus according to an embodiment of the present invention; and

FIG. 3 is a flowchart diagram of an audio signal processing method for use in an audio signal processing apparatus according to an embodiment of the present invention.

### DESCRIPTION OF THE PREFERRED EMBODIMENT

The content of the present invention will be explained with reference to embodiments thereof. However, the following embodiments are not intended to limit the present invention to any environment, applications, structures, process flows, or steps as described in these embodiments. Descriptions of the following embodiments are only for the purpose of explaining the present invention rather than to limit the present invention. In the following embodiments and drawings, elements not directly related to the present invention are all omitted from the depiction; and dimensional relationships among individual elements in the drawings are illustrated only for ease of understanding but not to limit the actual scale.

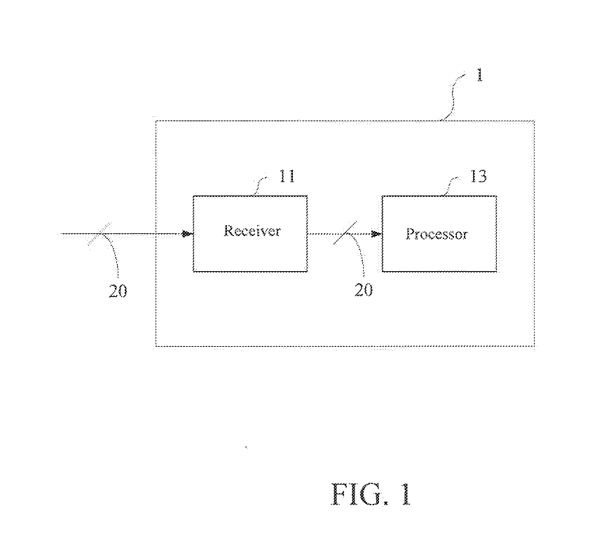

An embodiment of the present invention (briefly called “a first embodiment”) is an audio signal processing apparatus. FIG. 1 is a schematic structural view of an audio signal processing apparatus. As shown in FIG. 1, an audio signal processing apparatus 1 comprises a receiver 11 and a processor 13. The receiver 11 may be electrically connected with the processor 13 directly or indirectly, and can communicate and exchange information therewith. The audio signal processing apparatus 1 may be but not limited to apparatuses such as a desktop computer, a smart phone, a tablet computer, and a notebook computer. The receiver 11 may comprise various audio signal receiving interfaces and is configured to receive an audio signal 20 (including one audio signal or a plurality of audio signals), and may comprise various interfaces that communicate with the processor 13 to transmit the audio signal 20 to the processor 13. The audio signal 20 may be an acoustic signal with a non-specific time length.

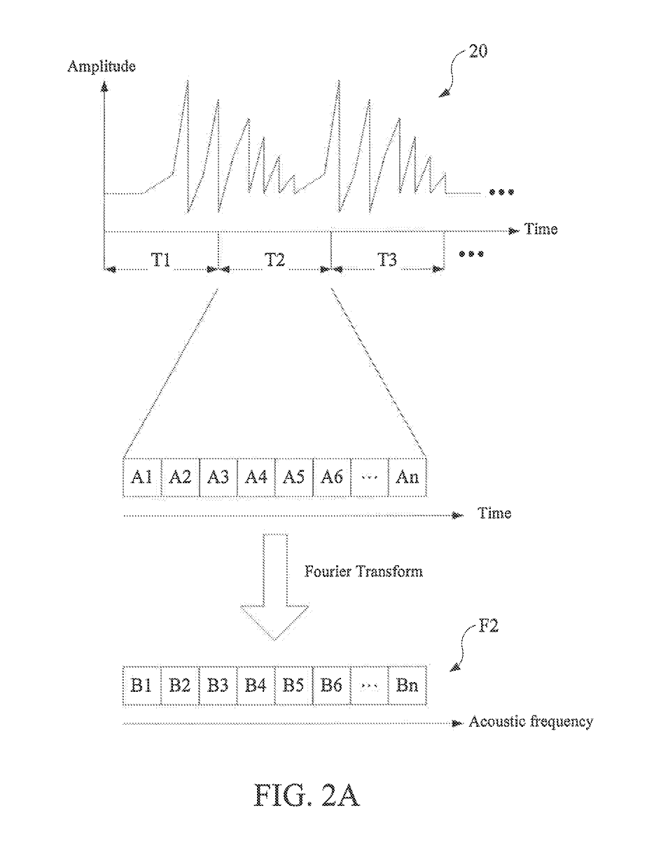

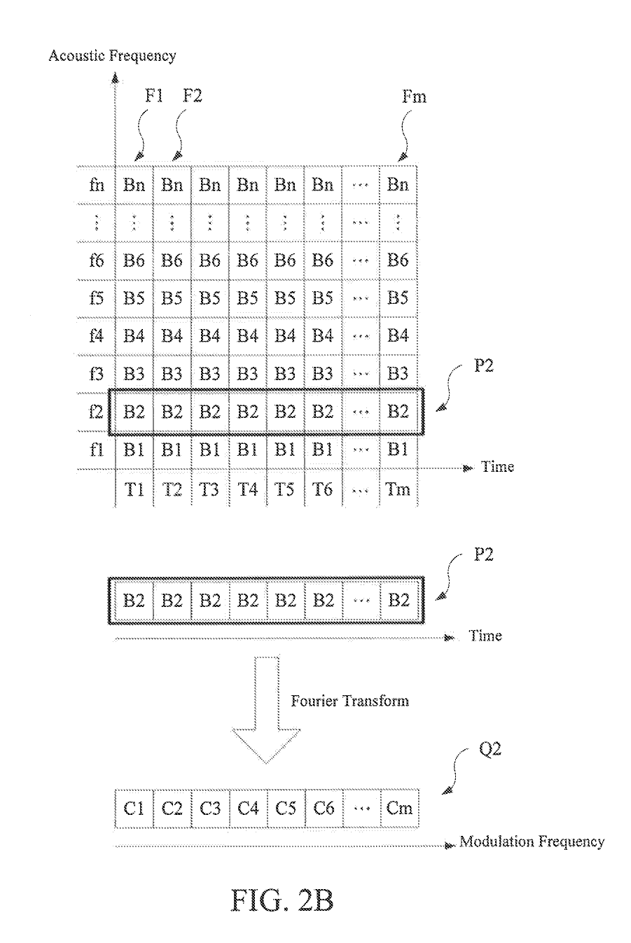

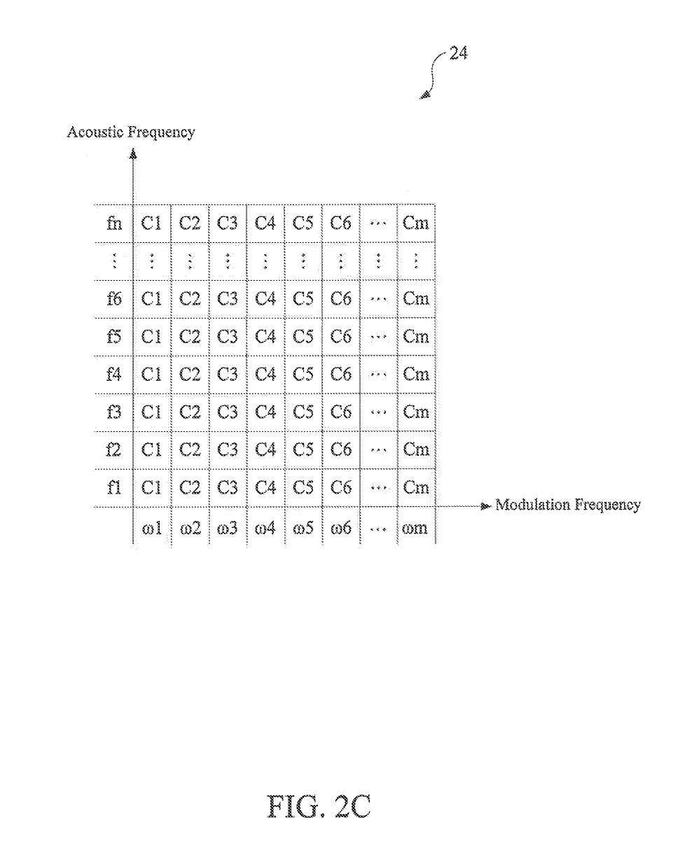

The processor 13 may be configured to execute the following operations after receiving the audio signal 20: dividing the audio signal 20 into a plurality of frames; applying Fourier Transform on each of the frames by the processor to obtain a plurality of acoustic spectra; applying Fourier Transform again on each of component combinations corresponding to respective acoustic frequencies in the acoustic spectra to obtain a two-dimensional joint frequency spectrum, wherein the two-dimensional joint frequency spectrum has an acoustic frequency dimension and a modulation frequency dimension; and calculating at least one feature of the audio signal 20 according to the two-dimensional joint frequency spectrum. FIG. 2A, FIG. 2B and FIG. 2C will be described together as an exemplary example to further describe the operations of the processor 13.

FIGS. 2A-2C are schematic views illustrating operations of the processor 13. As shown in FIG. 2A, the processor 13 may divide the audio signal 20 into a plurality of frames after receiving the audio signal 20. For example, the processor 13 may, depending on different needs, divide the audio signal 20 into m frames, namely, a frame T1, a frame T2, a frame T3, . . . , and a frame Tm (briefly called “T1˜Tm”), where m is a positive integer. For ease of description, each of the frames T1˜Tm may be represented by a vector. Taking the frame T2 shown in FIG. 2A as an example, the vector thereof is represented by signal amplitudes A1, A2, A3, A4, A5, A6, . . . , and An (briefly called “A1˜An”) corresponding to different times t1, t2, t3, t4, t5, t6, . . . , and to (briefly called “t1˜tn”), where n is a positive integer.

The processor 13 may apply Fourier Transform on each of the frames to obtain a plurality of corresponding acoustic spectra. For example, the processor 13 may apply Fourier Transform on each of the frames T1˜Tm to obtain an acoustic spectrum F1, an acoustic spectrum F2, an acoustic spectrum F3, an acoustic spectrum F4, an acoustic spectrum F5, an acoustic spectrum F6, . . . , and an acoustic spectrum Fm (briefly called “F1˜Fm”). For ease of description, each of the acoustic spectra F1˜Fm may be represented by a vector. Taking the acoustic spectrum F2 shown in FIG. 2A as an example, the vector thereof is represented by signal magnitudes B1, B2, B3, B4, B5, B6, . . . , and Bn (briefly called “B1˜Bn”) corresponding to different acoustic frequencies f1, f2, f3, f4, f5, f6, . . . , and fn (briefly called “f1˜fn”), where n is a positive integer. The Fourier Transform described in this embodiment may be considered as the Fast Fourier Transform, but this is not intended to limit the present invention.

As shown in FIG. 2B, through the Fourier Transform, the frames T1˜Tm will then correspond to the acoustic spectra F1˜Fm respectively. In the acoustic spectra F1˜Fm, the components corresponding to a same frequency are distributed in the frames T1˜Tm. For ease of description, these components corresponding to each of the frequencies and distributed in the frames T1˜Tm will be referred to as a component combination and are represented by a vector. In detail, the component combinations corresponding to frequencies f1˜fn and distributed in the frames T1˜Tm may be sequentially represented by a component combination P1, a component combination P2, a component combination P3, a component combination P4, a component combination P5, a component combination P6, . . . , and a component combination Pn (briefly called “P1˜Pn”).

The processor 13 may apply Fourier Transform again on each of the component combinations P1˜Pn to obtain a plurality of modulation spectra Q1˜Qn. For ease of description, each of the modulation spectra Q1˜Qn may be represented by a vector. Taking the modulation spectrum Q2 shown in FIG. 2B as an example, the vector thereof is represented by signal magnitudes C1, C2, C3, C4, CS, C6, . . . , and Cm (briefly called “C1˜Cm”) corresponding to different modulation frequencies ω1, ω2, ω3, ω4, ω5, ω6, . . . , and COM (briefly called “ω1˜ωm”), where m is a positive integer.

Through the aforesaid operations, the processor 13 may obtain a two-dimensional joint frequency spectrum 24 having an acoustic frequency dimension and a modulation frequency dimension as shown in FIG. 2C. Then, the processor 13 may calculate at least one feature of the audio signal 20 according to the two-dimensional joint frequency spectrum 24. In other embodiments, in order to analyze the magnitude of a harmonic wave (or an anharmonic wave) at different musical beat rates, the processor 13 may further decompose the two-dimensional joint frequency spectrum 24 into octave-based subbands along the acoustic frequency dimension, and decompose the two-dimensional joint frequency spectrum 24 into logarithmically spaced modulation subbands along the modulation frequency dimension, and then calculate at least one feature of the audio signal 20 according to the octave-based subbands and the logarithmically spaced modulation subbands. Because the method in which the octave-based subbands and the logarithmically spaced modulation subbands are calculated and effects thereof have already been known by those of ordinary skill in the art, they will not be described again herein.

The features of the audio signal 20 that are obtained through calculation according to the two-dimensional joint frequency spectrum 24 by the processor 13 may comprise but not limited to: an acoustic-modulation spectral peak (AMSP), an acoustic-modulation spectral valley (AMSV), an acoustic-modulation spectral contrast (AMSC), an acoustic-modulation spectral flatness measure (AMSFM) and an acoustic-modulation spectral crest measure (AMSCM).

The processor 13 may calculate the acoustic-modulation spectral peak and the acoustic-modulation spectral valley according to the following equations:

$$AMSP ( a , b ) = log ( \frac{1}{α {N}_{a , b}} {\sum }_{i = 1}^{α {N}_{a , b}} {S}_{a , b} [ i ] ) \\ AMSN ( a , b ) = log ( \frac{1}{α {N}_{a , b}} {\sum }_{i = 1}^{α {N}_{a , b}} {S}_{a , b} [ {N}_{a , b} - i + 1 ] ) \qquad ( 1 )$$

where S_{a,b}[i] is the i-th element corresponding to the a-th acoustic subband (and the a-th acoustic frequency among the acoustic frequencies f1˜fn) and the b-th modulation subband (and the b-th modulation frequency among the modulation frequencies ω1˜ωm) in the matrix of magnitude spectra S_{a,b}, N_{a,b} is the total number of elements in S_{a,b}, and a is a neighborhood factor. Optionally, a may be set to be greater than or equal to 1 and less than or equal to 8.

The processor 13 may calculate the acoustic-modulation spectral contrast according to the following equation:

AMSC(a,b)=AMSP(a,b)−AMSV(a,b) (2).

The processor 13 may calculate the acoustic-modulation spectral flatness measure according to the following equation:

$$AMSFM ( a , b ) = \frac{\sqrt[{N}_{a , b}]{{\prod }_{i = 1}^{{N}_{a , b}} {B}_{a , b} [ i ]}}{\frac{1}{{N}_{a , b}} {\sum }_{i = 1}^{{N}_{a , b}} {B}_{a , b} [ i ]} \qquad ( 3 )$$

where B_{a,b}[i] is the i-th element corresponding to the a-th acoustic subband (and the a-th acoustic frequency among the acoustic frequencies f1˜fn) and the b-th modulation subband (and the b-th modulation frequency among the modulation frequencies ω1˜ωm) in the matrix of magnitude spectra B_{a,b}, and N_{a,b} is the total number of elements in B_{a,b}.

The processor 13 may calculate the acoustic-modulation spectral crest measure according to the following equation:

$$AMSCM ( a , b ) = \frac{{max}_{i = 1 , K , {N}_{a , b}} ( {B}_{a , b} [ i ] )}{\frac{1}{{N}_{a , b}} {\sum }_{i = 1}^{{N}_{a , b}} {B}_{a , b} [ i ]} \qquad ( 4 )$$

where B_{a,b}[i] is the i-th element corresponding to the a-th acoustic subband (and the a-th acoustic frequency among the acoustic frequencies f1˜fn) and the b-th modulation subband (and the b-th modulation frequency among the modulation frequencies ω1˜ωm) in the matrix of magnitude spectra B_{a,b}, and N_{a,b} is the total number of elements in B_{a,b}.

After the aforesaid features or other features of the audio signal 20 are obtained through calculation according to the two-dimensional joint frequency spectrum 24 by the processor 13, the processor 13 may perform subsequent processing such as classifying, identifying, and tuning on the audio signal 20 according to the features obtained through calculation. For example, the processor 13 may distinguish a music genre of the audio signal 20 according to the features obtained through calculation, provide an equalizer parameter for the music genre of the audio signal 20, and tune the audio signal 20 according to the equalizer parameter.

In other embodiments, the audio signal processing apparatus 1 may further comprise a music genre database having various music genre information stored therein. The processor 13 may identify the audio signal 20 according to the music genre information provided by the music genre database so as to know the music genre corresponding to the audio signal 20. Specifically, the processor 13 may obtain the features of the audio signal 20 through calculation according to the two-dimensional joint frequency spectrum 24, and then determine what kind of music genre the features of the audio signal 20 corresponds to according to the music genre information provided by the music genre database. After having known the music genre corresponding to the audio signal 20, the processor 13 may automatically provide an equalizer parameter for the music genre according to various equalizer technologies, and tune the audio signal 20 according to the equalizer parameter.

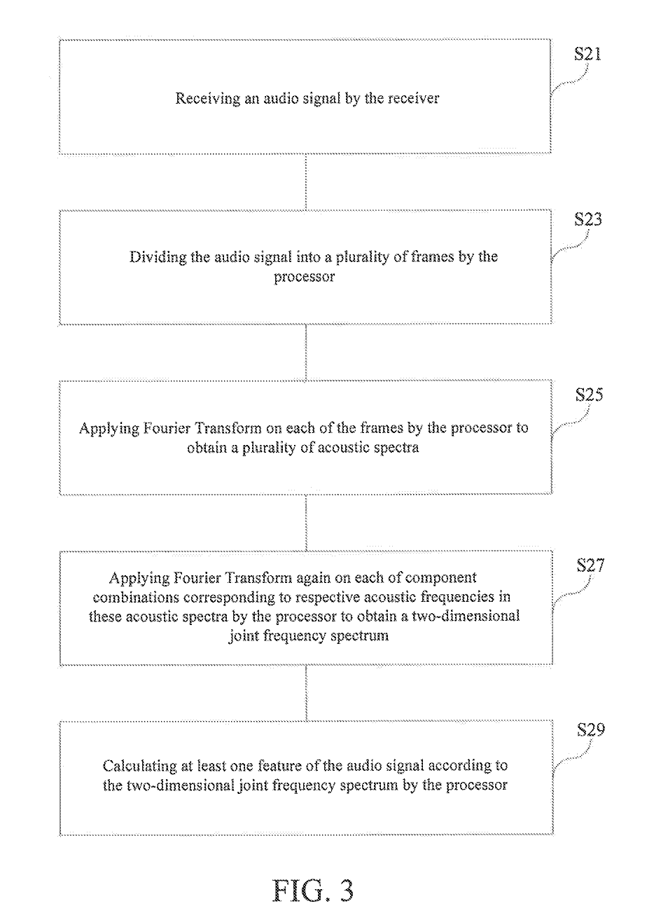

Another embodiment of the present invention (briefly called “a second embodiment”) is an audio signal processing method for use in an audio signal processing apparatus. The audio signal processing apparatus may comprise at least a receiver and a processor. For example, the second embodiment may be an audio signal processing method for use in the audio signal processing apparatus 1 of the first embodiment. FIG. 3 is a flowchart diagram of the audio signal processing method. As shown in FIG. 3, the audio signal processing method of the second embodiment comprises: a step S21 of receiving an audio signal by the receiver; a step S23 of dividing the audio signal into a plurality of frames by the processor; a step S25 of applying Fourier Transform on each of the frames by the processor to obtain a plurality of acoustic spectra; a step S27 of applying Fourier Transform again on each of component combinations corresponding to respective acoustic frequencies in these acoustic spectra by the processor to obtain a two-dimensional joint frequency spectrum, wherein the two-dimensional joint frequency spectrum has an acoustic frequency dimension and a modulation frequency dimension; and a step S29 of calculating at least one feature of the audio signal according to the two-dimensional joint frequency spectrum by the processor.

In other embodiments, the audio signal processing method of this embodiment further comprises the following steps of: decomposing the two-dimensional joint frequency spectrum into octave-based subbands along the acoustic frequency dimension by the processor; and decomposing the two-dimensional joint frequency spectrum into logarithmically spaced modulation subbands along the modulation frequency dimension by the processor.

In other embodiments, the at least one feature of the audio signal comprises an acoustic-modulation spectral peak and an acoustic-modulation spectral valley, and the processor calculates the acoustic-modulation spectral peak and the acoustic-modulation spectral valley according to the above equation (1).

In other embodiments, the at least one feature of the audio signal further comprises an acoustic-modulation spectral contrast, and the processor calculates the acoustic-modulation spectral contrast according to the above equation (2).

In other embodiments, the at least one feature of the audio signal comprises an acoustic-modulation spectral flatness measure, and the processor calculates the acoustic-modulation spectral flatness measure according to the above equation (3).

In other embodiments, the at least one feature of the audio signal comprises an acoustic-modulation spectral crest measure, and the processor calculates the acoustic-modulation spectral crest measure according to the above equation (4).

In other embodiments, the audio signal processing method of this embodiment further comprises the following steps of: distinguishing a music genre of the audio signal according to the at least one feature by the processor; providing an equalizer parameter for the music genre by the processor; and tuning the audio signal according to the equalizer parameter by the processor.

In addition to the aforesaid steps, the audio signal processing method of the second embodiment also comprises steps corresponding to all the operations of the audio signal processing apparatus 1 of the first embodiment. The corresponding steps that are not described in the audio signal processing method of the second embodiment will be readily appreciated by those of ordinary skill in the art based on the above disclosure of the first embodiment, and thus will not be further described herein.

According to the above descriptions, the present invention provides an audio signal processing apparatus and an audio signal processing method thereof. The audio signal processing apparatus and the audio signal processing method thereof can calculate a two-dimensional joint frequency spectrum for an audio signal, and then calculate features of the audio signal according to the two-dimensional joint frequency spectrum. Because the two-dimensional joint frequency spectrum is obtained by applying Fourier Transform on each of component combinations corresponding to respective acoustic frequencies in a plurality of acoustic spectra, the features that are obtained through calculation according to the two-dimensional joint frequency spectrum not only comprise frequency combinations within short-terms, but also take interactions between individual frames of the audio signal into account. Therefore, as compared to the features of the audio signal that are obtained through calculation according to the conventional audio signal processing technologies, the features that are obtained through calculation according to the two-dimensional joint frequency spectrum are more representative of the audio signal.

The above disclosure is related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An audio signal processing apparatus, comprising:
a receiver, configured to receive an audio signal; and
a processor electrically connected to the receiver, configured to divide the audio signal into a plurality of frames, apply Fourier Transform on each of the frames to obtain a plurality of acoustic spectra, apply Fourier Transform again on each of component combinations corresponding to respective acoustic frequencies in the acoustic spectra to obtain a two-dimensional joint frequency spectrum, and calculate at least one feature of the audio signal according to the two-dimensional joint frequency spectrum;
wherein the two-dimensional joint frequency spectrum has an acoustic frequency dimension and a modulation frequency dimension.

2. The audio signal processing apparatus as claimed in claim 1, wherein the processor is further configured to decompose the two-dimensional joint frequency spectrum into octave-based subbands along the acoustic frequency dimension, and decompose the two-dimensional joint frequency spectrum into logarithmically spaced modulation subbands along the modulation frequency dimension.

3. The audio signal processing apparatus as claimed in claim 1, wherein the at least one feature comprises an acoustic-modulation spectral peak (AMSP) and an acoustic-modulation spectral valley (AMSV), and the processor is configured to calculate the acoustic-modulation spectral peak and the acoustic-modulation spectral valley according to the following equations:
$$AMSP ( a , b ) = log ( \frac{1}{α {N}_{a , b}} {\sum }_{i = 1}^{α {N}_{a , b}} {S}_{a , b} [ i ] )$$
$$AMSV ( a , b ) = log ( \frac{1}{α {N}_{a , b}} {\sum }_{i = 1}^{α {N}_{a , b}} {S}_{a , b} [ {N}_{a , b} - i + 1 ] )$$
where S_{a/},[i] is the i-th element corresponding to the a-th acoustic subband and the b-th modulation subband in the matrix of magnitude spectra S_{a,b}, N_{a,b} is the total number of elements in S_{a,b}, and a is a neighborhood factor.

4. The audio signal processing apparatus as claimed in claim 3, wherein the at least one feature further comprises an acoustic-modulation spectral contrast (ASMC), and the processor is configured to calculate the acoustic-modulation spectral contrast according to the following equation:
AMSC(a, b)=AMSP(a,b)−AMSV(a,b).

5. The audio signal processing apparatus as claimed in claim 1, wherein the at least one feature comprises an acoustic-modulation spectral flatness measure (AMSFM), and the processor is configured to calculate the acoustic-modulation spectral flatness measure according to the following equation:
$$AMSFM ( a , b ) = \frac{\sqrt[{N}_{a , b}]{{\prod }_{i = 1}^{{N}_{a , b}} {B}_{a , b} [ i ]}}{\frac{1}{{N}_{a , b}} {\sum }_{i = 1}^{{N}_{a , b}} {B}_{a , b} [ i ]}$$
where B_{a,b}[i] is the i-th element corresponding to the a-th acoustic subband and the b-th modulation subband in the matrix of magnitude spectra B_{a,b}, and N_{a,b} is the total number of elements in B_{a,b}.

6. The audio signal processing apparatus as claimed in claim 1, wherein the at least one feature comprises acoustic-modulation spectral crest measure (AMSCM), and the processor is configured to calculate the acoustic-modulation spectral crest measure according to the following equation:
$$AMSCM ( a , b ) = \frac{{max}_{i = 1 , K , {N}_{a , b}} ( {B}_{a , b} [ i ] )}{\frac{1}{{N}_{a , b}} {\sum }_{i = 1}^{{N}_{a , b}} {B}_{a , b} [ i ]}$$
where B_{a,b}[i] is the i-th element corresponding to the a-th acoustic subband and the b-th modulation subband in the matrix of magnitude spectra B_{a,b}, and N_{a,b} is the total number of elements in B_{a,b}.

7. The audio signal processing apparatus as claimed in claim 1, wherein the processor is further configured to distinguish a music genre of the audio signal according to the at least one feature, provide an equalizer parameter for the music genre, and tune the audio signal according to the equalizer parameter.

8. An audio signal processing method for use in an audio signal processing apparatus, the audio signal processing apparatus comprising a receiver and a processor, the audio signal processing method comprising the following steps of:
receiving an audio signal by the receiver;
dividing the audio signal into a plurality of frames by the processor;
applying Fourier Transform on each of the frames by the processor to obtain a plurality of acoustic spectra;
applying Fourier Transform again on each of component combinations corresponding to respective acoustic frequencies in these acoustic spectra by the processor to obtain a two-dimensional joint frequency spectrum, wherein the two-dimensional joint frequency spectrum has an acoustic frequency dimension and a modulation frequency dimension; and
calculating at least one feature of the audio signal according to the two-dimensional joint frequency spectrum by the processor.

9. The audio signal processing method as claimed in claim 8, further comprising the following steps of:
decomposing the two-dimensional joint frequency spectrum into octave-based subbands along the acoustic frequency dimension by the processor; and
decomposing the two-dimensional joint frequency spectrum into logarithmically spaced modulation subbands along the modulation frequency dimension by the processor.

10. The audio signal processing method as claimed in claim 8, wherein the at least one feature comprises an acoustic-modulation spectral peak (AMSP) and an acoustic-modulation spectral valley (AMSV), and the processor calculates the acoustic-modulation spectral peak and the acoustic-modulation spectral valley according to the following equation:
$$AMSP ( a , b ) = log ( \frac{1}{α {N}_{a , b}} {\sum }_{i = 1}^{α {N}_{a , b}} {S}_{a , b} [ i ] )$$
$$AMSV ( a , b ) = log ( \frac{1}{α {N}_{a , b}} {\sum }_{i = 1}^{α {N}_{a , b}} {S}_{a , b} [ {N}_{a , b} - i + 1 ] )$$
where S_{a,b}[i] is the i-th element corresponding to the a-th acoustic subband and the b-th modulation subband in the matrix of magnitude spectra S_{a,b}, N_{a,b} is the total number of elements in S_{a,b}, and a is a neighborhood factor.

11. The audio signal processing method as claimed in claim 10, wherein the at least one feature further comprises an acoustic-modulation spectral contrast (ASMC), and the processor calculates the acoustic-modulation spectral contrast according to the following equation:
AMSC(a,b)=AMSP(a,b)−AMSV(a,b).

12. The audio signal processing method as claimed in claim 8, wherein the at least one feature comprises an acoustic-modulation spectral flatness measure (AMSFM), and the processor calculates the acoustic-modulation spectral flatness measure according to the following equation:
$$AMSFM ( a , b ) = \frac{\sqrt[{N}_{a , b}]{{\prod }_{i = 1}^{{N}_{a , b}} {B}_{a , b} [ i ]}}{\frac{1}{{N}_{a , b}} {\sum }_{i = 1}^{{N}_{a , b}} {B}_{a , b} [ i ]}$$
where B_{a,b}[i] is the i-th element corresponding to the a-th acoustic subband and the b-th modulation subband in the matrix of magnitude spectra B_{a,b}, and N_{a,b} is the total number of elements in B_{a,b}.

13. The audio signal processing method as claimed in claim 8, wherein the at least one feature comprises acoustic-modulation spectral crest measure (AMSCM), and the processor calculates the acoustic-modulation spectral crest measure according to the following equation:
$$AMSCM ( a , b ) = \frac{{max}_{i = 1 , K , {N}_{a , b}} ( {B}_{a , b} [ i ] )}{\frac{1}{{N}_{a , b}} {\sum }_{i = 1}^{{N}_{a , b}} {B}_{a , b} [ i ]}$$
where B_{a,b}[i] is the i-th element corresponding to the a-th acoustic subband and the b-th modulation subband in the matrix of magnitude spectra B_{a,b}, and N_{a,b} is the total number of elements in B_{a,b}.

14. The audio signal processing method as claimed in claim 8, further comprising the following steps of:
distinguishing a music genre of the audio signal according to the at least one feature by the processor;
providing an equalizer parameter for the music genre by the processor; and
tuning the audio signal according to the equalizer parameter by the processor.
